(19) United States
(12) Patent Application Publication
(10) Pub. No.: US 2018/0090062 A1
(43) Pub. Date: Mar. 29, 2018

(54) DISPLAY DEVICE

(71) Applicant: Japan Display Inc., Tokyo (JP)

(72) Inventor: Norio NAKAMURA, Tokyo (JP)

(21) Appl. No.: 15/682,606

(22) Filed: Aug. 22, 2017

(30) Foreign Application Priority Data
Sep. 29, 2016 (JP) 2016-191344

(51) Int. Cl. G09G 3/3225

(52) U.S. Cl. CPC G09G 3/3225; G09G 2320/041

(57) ABSTRACT

Provided is a display device that includes a temperature sensor providing measurement values that are not much dispersed and controls the level of a cathode current based on the measurement values. A display device includes a plurality of pixels provided on a substrate, the plurality of pixels each including a light emitting element and a pixel circuit to which a gray scale signal is input; a temperature sensor circuit provided on the substrate, the temperature sensor circuit including a temperature sensor line and detecting a temperature on the basis of a temperature dependence of a resistance change ratio of the temperature sensor line; and a gray scale signal control circuit correcting the gray scale signal in accordance with the temperature.

### CROSS REFERENCE TO RELATED APPLICATIONS

This application is based upon and claims the benefit of priority from the prior Japanese Patent Application No. 2016-191344 filed on Sep. 29, 2016, the entire contents of which are incorporated herein by reference.

### FIELD

The present invention relates to a display device.

### BACKGROUND

An organic electroluminescence (hereinafter, referred to as “organic EL”) display device includes a light emitting element in each of a plurality of pixels, and displays an image by controlling light emission in each of the pixels individually. The light emitting element includes a pair of electrodes, one of which is an anode electrode and the other of which is a cathode electrode, and a layer containing an organic EL material (hereinafter, referred to as a “light emitting layer”) held between the pair of electrodes. In such an organic EL display device, the one of the electrodes is provided, as a pixel electrode, in each of the pixels, and the other of the electrodes is provided, as a common electrode, commonly to the plurality of pixels. The common electrode is supplied with a common potential. The organic EL display device applies a potential of the pixel electrode in each pixel with respect to the potential of the common electrode, and thus controls the light emission of each pixel.

When the temperature of the organic EL display device is made high due to the external environment or heat generation in the organic EL display device itself, the level of a cathode current is increased. This causes problems that the light emission luminance of the organic EL display device is changed in accordance with the temperature, that the power consumption is increased, and that deterioration of the pixels is promoted.

Conventionally in order to solve these problems, the level of the cathode current at normal temperature is set to be low, so that the standards for the electric current are satisfied even at a high temperature. However, when the level of the cathode current at normal temperature is set to be low, the light emission luminance at normal temperature is low.

For example, Japanese PCT National-Phase Laid-Open Patent Publication No. 2009-515219 describes a method for compensating for an image signal usable to drive an OLED display including a plurality of light emitting elements, the output of which changes along with time or as being used. The method includes the steps of (a) acquiring a first measurement value or a first estimation value of current consumed by each of the light emitting elements in first response to a known image signal; (b) specifying a plurality of groups of light emitting elements, such that at least one of the specified groups includes at least one light emitting element that is common to another of the specified groups; (c) measuring a total value of current consumed by the specified groups in second response to the known image signal; (d) forming a second estimation value of current consumed by each of the light emitting elements based on the measured total value; (e) calculating a correction value on each of the light emitting elements based on the difference between the first current value and the second current value; and (f) compensating for the change in the output of the light emitting element by using the corrected value on the image signal to generate a compensated image signal.

Japanese Laid-Open Patent Publication No. 2009-169377 discloses an organic field light emission display device including a pixel portion including a great number of pixels located at intersections of data lines, scanning lines and light emission control lines; a temperature sensor provided to measure the temperature of the pixel portion; a first analog-digital converter (first ADC) converting temperature information provided by the temperature sensor into a digital value; a control portion receiving an input of the digital value that is output from the first ADC and outputting a control signal corresponding to the digital value; a sensing portion extracting a deterioration degree of an organic light emitting diode included in each of the pixels; a second analog-digital converter (second ADC) receiving an input of deterioration information on the organic light emitting diode extracted by the sensing portion and an input of the control signal that is output from the control portion and generating a digital value corresponding to the deterioration information on the organic light emitting diode that is variable in accordance with the temperature; a conversion portion converting input data Data into calibrated data Data′ such that a video of a uniform luminance is displayed by use of the digital value that is output from the second ADC regardless of the change in the deterioration degree of the organic light emitting element in accordance with the temperature; and a data driving portion receiving an input of the calibrated data Data′ that is output from the conversion portion and generating a data signal to be supplied to the pixel.

### SUMMARY

In an embodiment according to the present invention, a display device includes a plurality of pixels provided on a substrate, the plurality of pixels each including a light emitting element and a pixel circuit to which a gray scale signal is input; a temperature sensor circuit provided on the substrate, the temperature sensor circuit including a temperature sensor line and detecting a temperature on the basis of a temperature dependence of a resistance change ratio of the temperature sensor line; and a gray scale signal control circuit correcting the gray scale signal in accordance with the temperature.

### BRIEF DESCRIPTION OF DRAWINGS

FIG. 1 is a perspective view showing a structure of a display device in one embodiment according to the present invention;

FIG. 2 is a plan view showing the structure of the display device in the one embodiment according to the present invention;

FIG. 3 is a cross-sectional view showing the structure of the display device in the one embodiment according to the present invention;

FIG. 4 is a block diagram showing the structure of the display device in the one embodiment according to the present invention;

FIG. 5 is a circuit diagram showing a structure of a pixel circuit included in the display device in the one embodiment according to the present invention;

FIG. 6 is a plan view showing a structure of a display device in another embodiment according to the present invention;

FIG. 7 is a plan view showing a structure of a display device in still another embodiment according to the present invention;

FIG. 8 is a plan view showing a structure of a display device in yet another embodiment according to the present invention;

FIG. 9 is a circuit diagram showing a structure of an investigation circuit included in the display device in the yet another embodiment according to the present invention;

FIG. 10 is a graph showing data representing the temperature dependence of the resistance value of a temperature sensor line in an example according to the present invention; and

FIG. 11 is a graph showing data representing the temperature dependence of the resistance change ratio of the temperature sensor line in the example according to the present invention.

### DESCRIPTION OF EMBODIMENTS

Hereinafter, embodiments of the present invention will be described with reference to the drawings and the like. The present invention may be carried out in various other embodiments, and should not be construed as being limited to any of the following embodiments. In the drawings, components may be shown schematically regarding the width, thickness, shape and the like, instead of being shown in accordance with the actual sizes, for the sake of clear illustration. The drawings are merely examples and do not limit the interpretations of the present invention in any way. In the specification and the drawings, components that are substantially the same as those described or shown previously bear the identical reference signs thereto, and detailed descriptions thereof may be omitted.

### Embodiment 1

### [Structure]

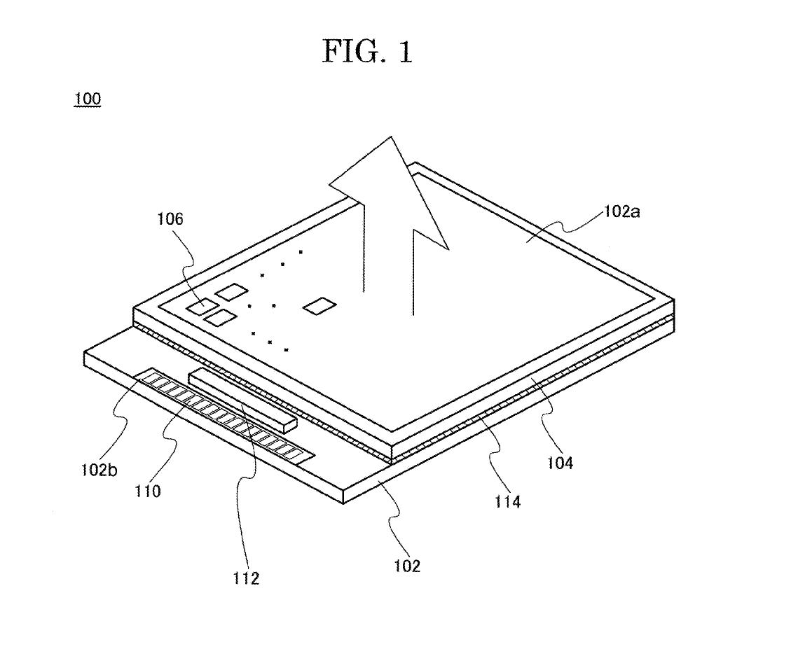

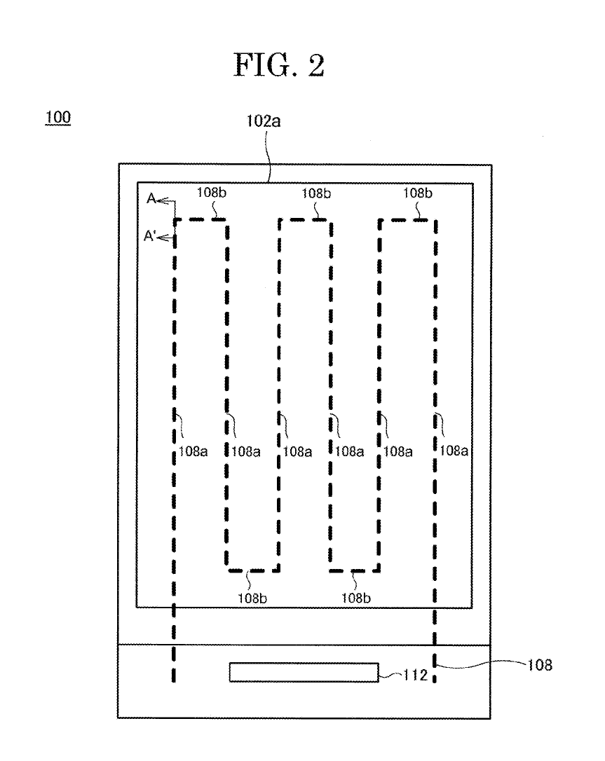

FIG. 1 is a perspective view showing a structure of a display device 100 in embodiment 1. FIG. 2 is a plan view showing the structure of the display device 100 in this embodiment. The display device 100 in this embodiment includes a first substrate 102, a second substrate 104, a plurality of pixels 106, a temperature sensor line 108, a plurality of connection terminals 110, and a driver IC 112.

The first substrate 102 acts as a support for the plurality of pixels 106. The first substrate 102 includes a display region 102a where the plurality of pixels 106 are arrayed. The first substrate 102 may be a glass substrate, an acrylic resin substrate, an alumina substrate, a polyimide substrate or the like.

The second substrate 104 is provided on the display region 102a so as to face the first substrate 102. The second substrate 104 is secured to the first substrate 102 by a sealing member 114 enclosing a periphery of the second substrate 104. The second substrate 104 may be formed of substantially the same material as that of the first substrate 102. The display device 100 in this embodiment is not limited to including a plate-like member such as the second substrate 104 or the like, and the second substrate 104 may be replaced with a film substrate or a sealing substrate coated with a resin or the like.

The plurality of pixels 106 are arrayed in a matrix, namely, in rows and columns, on the first substrate 102. The plurality of pixels 106 each include a pixel circuit 128. As described below in detail, the pixel circuit 128 includes at least a driving transistor 134, a selection transistor 136, a light emitting element 138, and a storage capacitance 140.

The temperature sensor line 108 is located in the display region 102a. As described below in detail, in this embodiment, the temperature of the display device 100, especially of the display region 102a, is sensed based on a resistance change ratio of the temperature sensor line 108. In this embodiment, at least a part of the temperature sensor line 108 is located in the display region 102a. The temperature sensor line 108 includes six vertical portions 108a extending in a vertical direction, namely, in a column direction, of the display region 102a and five horizontal portions 108b each connecting two vertical portions 108a adjacent thereto among the six vertical portions 108a. The vertical portions 108a are located at a substantially equal interval in the display region 102a. The five horizontal portions 108b are each located in the vicinity of a top end or a bottom end of the display region 102a. Since the six vertical portions 108a are located at a substantially equal interval, the temperature of the display device 100, especially of the display region 102a, is accurately sensed.

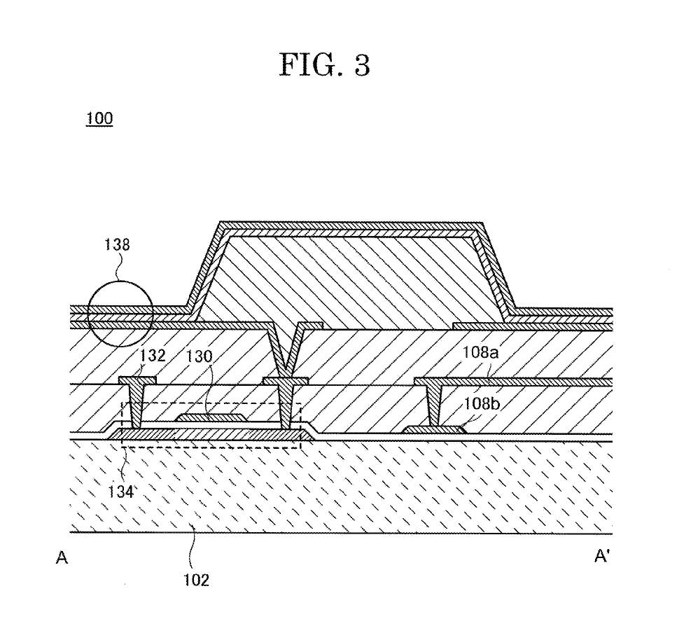

There is no specific limitation on the layer in which the temperature sensor line 108 is provided. FIG. 3 is a cross-sectional view showing an example of layer structure of the temperature sensor line 108. FIG. 3 is taken along line A-A′ in FIG. 2. In this example, a scanning signal line 130 is located in the same layer as that of a gate of the driving transistor 134. A video signal line is located in a layer above the layer in which the driving transistor 134 is located, and is conductive with a source of the driving transistor 134 via a contact hole. At least a part of the temperature sensor line 108 may be located in the same layer as that of the scanning signal line 130 or the video signal line 132, both of which are connected with each of the plurality of pixels 106. Namely, as shown in FIG. 3, the vertical portion 108a may be located in the same layer as that of the video signal line 132 (described below in detail), and the horizontal portion 108b may be located in the same layer as that of the scanning signal line 130. In this case, the vertical portion 108a and the horizontal portion 108b need to be conductive with each other, and a contact electrode may be provided for this purpose. A contact hole provided to form the contact electrode may be formed in the same step as the contact hole reaching the source and the drain of the driving transistor 134 because the vertical portion 108a of the temperature sensor line 108 acts as an etching stopper. In another example, a line layer in which the temperature sensor line 108 is located may be further provided.

The plurality of connection terminals 110 are located along an end of the first substrate 102 and outer to the second substrate 102. The first substrate 102 includes a terminal region 102b where the plurality of connection terminals 110 are located. The plurality of connection terminals 110 are each connected with a line substrate (not shown) connecting a device outputting a video signal or a power supply to the display device 100. A contact of each of the plurality of connection terminals 110 with the line substrate is exposed outside.

The driver IC 112 is located along the end of the first substrate 102 and outer to the second substrate 104. The driver IC 112 outputs video signals, input from the connection terminals 110, to the display region 102a.

### [Circuit Configuration]

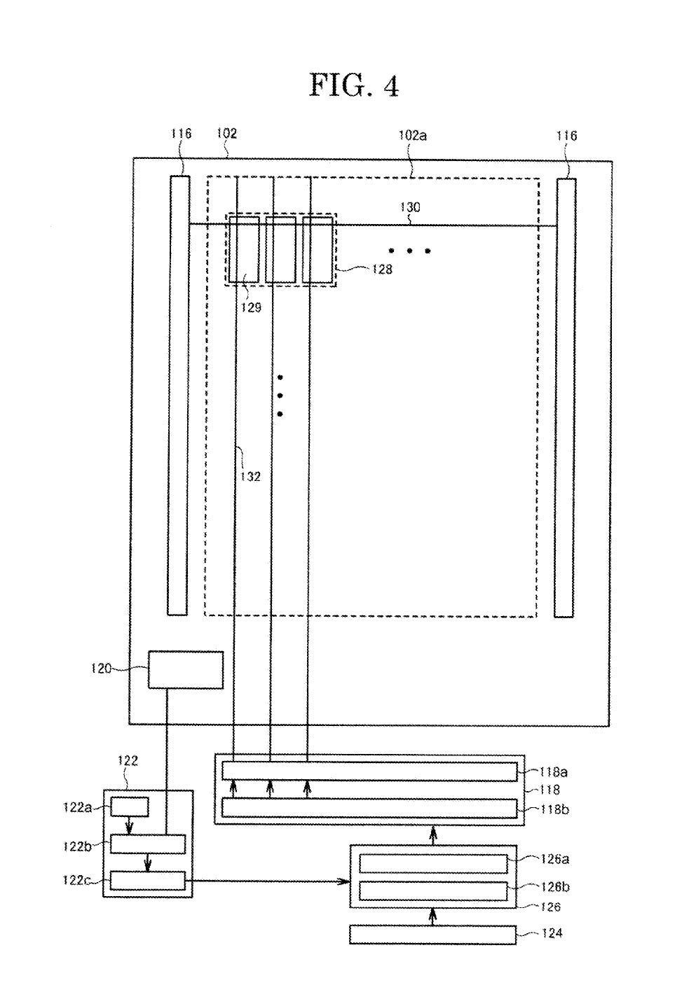

FIG. 4 is a block diagram showing the structure of the display device 100 in this embodiment. The display device 100 in this embodiment includes a scanning signal line driving circuit 116, a video signal line driving circuit 118, a temperature sensor circuit 120, a temperature gain acquisition circuit 122, an input circuit 124, a gray scale signal control circuit 126, the plurality of pixel circuits 128, a plurality of the scanning signal lines 130, and a plurality of the video signal lines 132.

The scanning signal line driving circuit 116 is connected with the plurality of scanning signal lines 130. The plurality of scanning signal lines 130 are respectively provided for a plurality of pixel rows extending in a horizontal direction. The scanning signal line driving circuit 116 sequentially selects the plurality of scanning signal lines 130 in accordance with a timing signal input from a control device.

The plurality of pixel circuits 128 are arrayed in a matrix. The plurality of pixel circuits 128 each include a plurality of sub pixel circuits 129. In this embodiment, each pixel circuit 128 includes three sub pixel circuits 129, more specifically, a sub pixel circuit 129 controlling light emission of red, a sub pixel circuit 129 controlling light emission of green, and a sub pixel circuit 129 controlling light emission of blue. The sub pixel circuits 129 each control the light emission such that light is emitted in correspondence with an input gray scale signal.

Now, the circuit configuration of each of the plurality of pixel circuits 128 included in the display device 100 in this embodiment will be described in detail. The plurality of pixel circuits 128 each include a plurality of transistors. In the following description, a gate terminal of each of the transistors will be referred to as a control terminal. For the sake of convenience, either one of a source terminal and a drain terminal of the transistor will be referred to as a “first terminal”, and the other of the source terminal and the drain terminal will be referred to as a “second terminal”. Namely, the first terminal of the transistor may act as a source terminal or a drain terminal in accordance with the conditions in which a voltage is applied. The same is applicable to the second terminal.

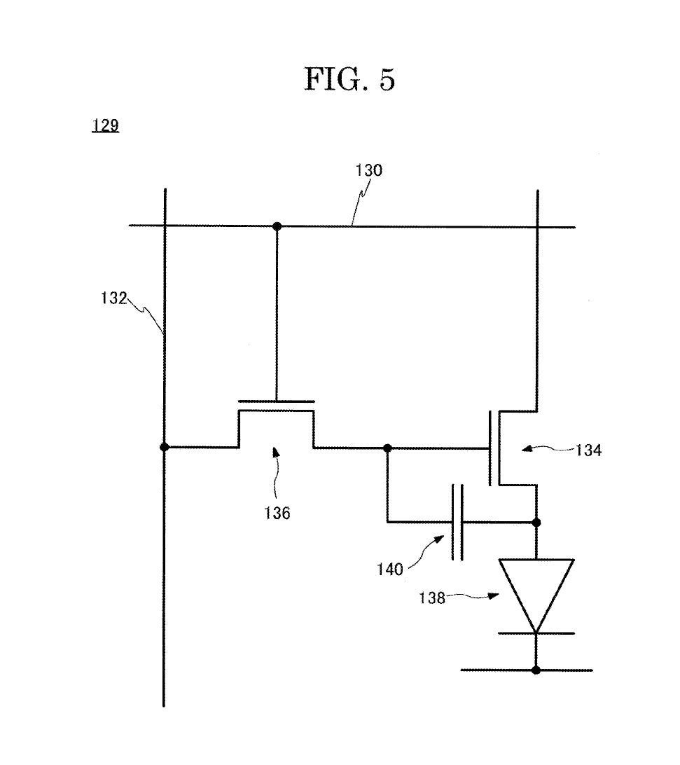

FIG. 5 is a circuit diagram showing a structure of each of the sub pixel circuits 129 included in the display device 100 in this embodiment. In this embodiment, each pixel circuit 128 includes three sub pixel circuits 129. Specifically, the three sub pixel circuits 129 respectively control light emission of red, green and blue. The three sub pixel circuits 129 each include the driving transistor 134, the selection transistor 136, the light emitting element 138 and the storage capacitance 140. In this embodiment, the driving transistor 134 and the selection transistor 136 are both n-channel transistors.

The driving transistor 134 supplies a current, corresponding to a potential applied to the control terminal, to the light emitting element 138. While the display device 100 is driven, the driving transistor 134 is driven in a saturated state. The driving transistor 134 includes the control terminal, the first terminal and the second terminal. The control terminal of the driving transistor 134 is connected to the second terminal of the selection transistor 136, the first terminal of the driving transistor 134 is connected to a power supply line, and the second terminal of the driving transistor 134 is connected to an anode electrode of the light emitting element 138.

The selection transistor 136 is turned on or off to control the conductive state between the video signal line 132 and the control terminal of the driving transistor 134. The control terminal of the selection transistor 136 is connected with the scanning signal line 130, the first terminal of the selection transistor 136 is connected with the video signal line 132, and the second terminal of the selection transistor 136 is connected with the control terminal of the driving transistor 134.

The storage capacitance 140 retains the voltage between the control terminal and the second terminal of the driving transistor 134. Even after the selection transistor 136 is put into a non-conductive state, a voltage is applied to the control terminal of the driving transistor 134 for a certain period because of charges accumulated in the storage capacitance 140, and thus the driving transistor 134 is kept conductive. The storage capacitance 140 is connected between the control terminal and the second terminal of the driving transistor 134.

The light emitting element 138 includes the anode, a light emitting layer and a cathode stacked in this order. The anode of the light emitting element 138 is connected with the second terminal of the driving transistor 134, and the cathode of the light emitting element 138 is connected with a common potential line. The light emitting element 138 may be of a current-driven type, which emits light of a luminance corresponding to the supplied current. In this embodiment, the light emitting element 138 is an organic light emitting diode.

The circuit configuration of each of the plurality of pixel circuits 128 included in the display device 100 in this embodiment has been described.

The plurality of scanning signal lines 130 are each connected with a plurality of pixel circuits 128 located in one row, among the plurality of pixel circuits 128 arrayed in the matrix. More specifically, the plurality of scanning signal lines 130 are each connected with sets of three sub pixel circuits 129 included in the plurality of pixel circuits 128 located in the corresponding pixel row.

The plurality of video signal lines 132 are each connected with a plurality of pixel circuits 128 located in one column, among the plurality of pixel circuits 128 arrayed in the matrix.

The temperature sensor circuit 120 is located on the first substrate 120. The temperature sensor circuit 120 includes the temperature sensor line 108. The layout of the temperature sensor line 108 is as described above. The temperature sensor circuit 120 is provided in order to detect the temperature based on the temperature dependence of the resistance change ratio of the temperature sensor line 108. The temperature sensor circuit 120 detects the temperature at a predetermined cycle while the plurality of pixels 106 are driven. The predetermined cycle may be, for example, a cycle of 1 second or shorter, a cycle of 10 seconds or shorter, a cycle of 1 minute or shorter, or a cycle of 10 minutes or shorter.

In this embodiment, the resistance change ratio is calculated based on the resistance value (R_{ref}) of the temperature sensor line 108 at a predetermined reference temperature (T_{ref}). This will be described more specifically. The resistance values (R) of the temperature sensor line 108 at a plurality of sample temperatures including the predetermined reference temperature (T_{ref}) are acquired in advance and stored on a memory included in the display device 100. For example, during the production of the display device 100, a predetermined reference voltage (V_{ref}) is applied to the temperature sensor line 108, and a reference current (I_{ref}) flowing in the temperature sensor line 108 and a reference resistance value (R_{ref}=V_{ref}/I_{ref}) is acquired. The predetermined reference temperature (T_{ref}) is not specifically limited to any temperature, and may be any temperature in the range of 0° C. or higher and 70° C. or lower. Preferably, the predetermined reference temperature (T_{ref}) may be any temperature in the range of 15° C. or higher and 35° C. or lower.

For detecting the temperature of the display device 100 while the display device 100 is driven, the above-described reference voltage V_{ref} is applied to the temperature sensor line 108. Where the level of the current flowing in the temperature sensor line 108 detected by the voltage application (sensed current level) is Iₛₑₙₛₑ and the resistance value thus calculated is Rₛₑₙₛₑ, the resistance change ratio is defined by, for example, (Rₛₑₙₛₑ−R_{ref})/R_{ref}. This definition of the resistance change ratio may be represented as, by use of various current values, 1/((Iₛₑₙₛₑ/I_{ref})−1). Namely, calculation of the temperature based on the resistance change ratio is equivalent to calculation of the temperature based on Iₛₑₙₛₑ/I_{ref}, which is the ratio of the sensed current with respect to the reference current. A structure and a method for detecting the resistance value of the temperature sensor line 108 will be described in detail below.

A single temperature sensor line 108, or a plurality of the temperature sensor lines 108, may be provided. In the case where the plurality of temperature sensor lines 108 are provided, an average of temperatures detected by the plurality of temperature sensor lines 108 may be used. Alternatively, for example, an average of resistance change ratios of the plurality of temperature sensor lines 108 may be used to calculate the temperature.

According to a conventional technology, the temperature sensor is provided in an OLED panel, and the level of a cathode current is controlled by the measurement value of the temperature. However, the detailed structure of the temperature sensor in such a conventional technology is not clear.

Conventionally, for example, a thermistor, which is a resistor having an electric resistance value that is changed relatively greatly in accordance with the temperature change, is often used as the temperature sensor. However, such a thermistor provides dispersed measurement values and thus may not accurately measure the temperature of the panel.

The present invention, made in the above-described situation, has an object of providing a display device that includes a temperature sensor providing measurement values that are not much dispersed and controls the level of a cathode current based on the measurement values.

Namely, the display device 100 in this embodiment detects the temperature thereof by use of the temperature dependence of the resistance change ratio of the temperature sensor line 108. As described below in an example in detail, the display device 100 in this embodiment, because of this structure, keeps the detected temperatures less dispersed than the conventional display device. In other words, the display device 100 in this embodiment senses the temperature more precisely than the conventional display device.

The temperature gain acquisition circuit 122 is connected with the temperature sensor circuit 120 and determines the temperature of the display device 100. The temperature gain acquisition circuit 122 determines a gain G of a gray scale signal in accordance with the temperature. The temperature gain acquisition circuit 122 includes a sensor power supply circuit 122a, a current measurement circuit 122b, and a temperature gain computation circuit 122c.

The sensor power supply circuit 122a supplies a power supply usable to drive the current measurement circuit 122b. The current measurement circuit 122b is connected with the temperature sensor line 108, and applies the reference voltage (V_{ref}) between two points of the temperature sensor line 108. Thus, the current measurement circuit 122b detects the level of the current (Iₛₑₙₛₑ) flowing in the temperature sensor line 108.

The resistance value of the temperature sensor line 108 at the time of the detection is calculated with Rₛₑₙₛₑ=V_{ref}/Iₛₑₙₛₑ. The resistance change ratio of the temperature sensor line 108 is calculated by use of the above-described definition of the resistance change ratio ((Rₛₑₙₛₑ−R_{ref})/R_{ref}). From the resistance change ratio, the temperature of the display device 100 is calculated. Alternatively, 1/((Iₛₑₙₛₑ/I_{ref})−1) may be used as the resistance change ratio represented by use of various current values as described above.

The temperature gain computation circuit 122c determines the gain G so as to decrease the temperature dependence of the level of the current passing the cathode. As described above, when the temperature of the display device 100 is increased while the voltage applied between the anode and the cathode of the light emitting element 138 is constant, the level of the current flowing in the cathode and the anode is increased. As a result, the luminance of the light emitted by the light emitting element 138 is increased although the level of the gray scale input in accordance with the display image is constant. In order to suppress such a change in the luminance in accordance with the temperature, the level of the input gray scale may be adjusted in accordance with the temperature.

The grain G adjusts the level of the input gray scale such that the anode current in the case where the red, green and blue sub pixels have a gray scale level of 255 (at the time of displaying white) at the reference temperature (T_{ref}) is kept constant at any temperature environment. More specifically, the gain G is calculated such that the level of the anode current in the case where a gray scale level of 255 is input at the reference temperature (T_{ref}) is equal to the level of the anode current in the case where a gray scale level of an integer closest to the logical product of 255 and the grain G is input at any temperature environment.

The input circuit 124 receives, from an external circuit, an input of a gray scale signal corresponding to the display image, and outputs the gray scale signal to the gray scale signal control circuit 126. In this embodiment, the gray scale signal corresponding to each of the red, green and blue sub pixel circuits is represented by 8 bits. Namely, the gray scale signal is represented in 256-levels from level 0 to lever 255. Level 0 indicates that no light is emitted, and level 255 indicates that the luminance of the light is highest.

The gray scale signal control circuit 126 includes a gamma correction circuit 126a and a gray scale signal correction circuit 126b. The gray scale signal control circuit 126 receives an input of a gray scale signal from the input circuit 124 and corrects the gray scale signal as described below. Then, the gray scale signal control circuit 126 outputs the corrected gray scale signal to the video signal line driving circuit 118.

The gray scale signal correction circuit 126b corrects the gray scale signal in accordance with the temperature detected by the temperature sensor circuit 120. Specifically, the gray scale signal correction circuit 126b corrects the gray scale signal in accordance with the gain G determined by the temperature gain computation circuit 122c. More specifically, the gray scale signal correction circuit 126b multiplies the gray scale signal by the gain G calculated by the temperature gain computation circuit 122c to generate the corrected gray scale signal. The gain G used at any temperature environment is acquired in advance during the production of the display device 100 and stored on a memory included in the display device 100. The gray scale signal correction circuit 126b corrects the gray scale signal by referring to a lookup table in accordance with the gain G.

The gamma correction circuit 126a corrects the gray scale signal in accordance with a gamma value of the gray scale signal. Specifically, the gamma correction circuit 126a corrects the gray scale signal by referring to a lookup table in accordance with the gain G.

The video signal line driving circuit 118 includes a DA converter 118a and an amplifier circuit 118b. The video signal line driving circuit 118 is connected with the plurality of video signal lines 132.

The DA converter 118a receives the corrected gray scale signal from the gray scale signal control circuit 126. In this embodiment, the corrected gray scale signal is 8-bit digital data, and is converted by the DA converter 118a into analog data of a potential corresponding to the digital data.

The amplifier circuit 118b receives an input of the converted analog data from the DA converter 118a. The amplifier circuit 118b converts the analog data into a video signal of a predetermined potential.

The structure of the display device 100 in this embodiment has been described. The display device 100 in this embodiment uses the temperature dependence of the resistance change ratio of the temperature sensor line 108 to detect the temperature of the display device 100. The display device 100 in this embodiment, because of this structure, keeps the detected temperatures less dispersed than the conventional display device. In other words, the display device 100 in this embodiment senses the temperature more precisely than the conventional display device.

In addition, the level of the cathode current in the display device 100 is adjusted to be constant based on the temperature of the display device 100 determined as described above. As a result, even if the temperature environment of the display device 100 is changed, the level of the cathode current is kept constant highly precisely, and the change in the luminance of the light emitted by the display device 100 is suppressed.

### Embodiment 2

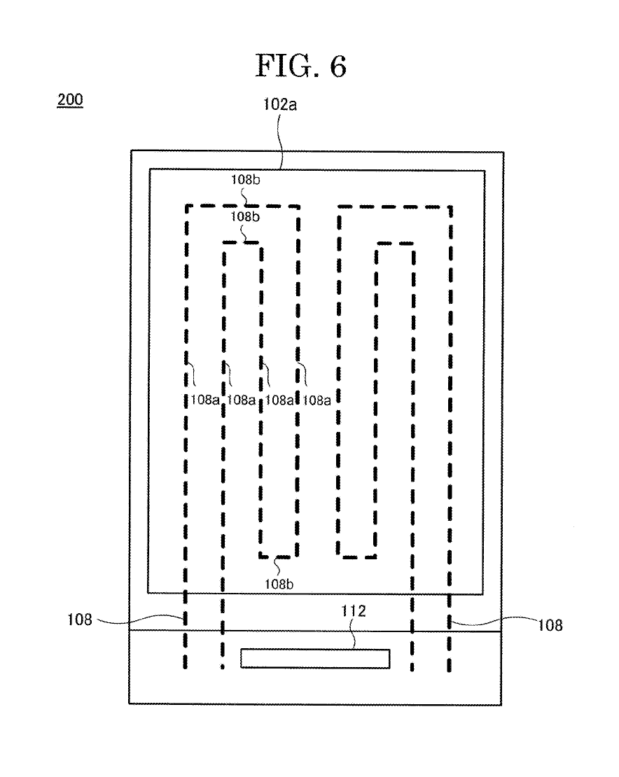

With reference to the drawings, a structure of a display device 200 in embodiment 2 will be described. FIG. 6 is a plan view showing the structure of the display device 200 in this embodiment. The display device 200 in this embodiment is different in the layout of the temperature sensor line 108 from the display device 100 in embodiment 1.

In this embodiment, two temperature sensor lines 108 are provided. The two temperature sensor lines 108 each include, in the display region 102a, four vertical portions 108a extending in the vertical direction and three horizontal portions 108b connecting the four vertical portions 108a. The vertical portions 108a are located at a substantially equal interval in the display region 102a. The three horizontal portions 108b are each located in the vicinity of the top end or the bottom end of the display region 102a. Since the four vertical portions 108a are located at a substantially equal interval, the temperature of the display device 100, especially of the display region 102a, is accurately sensed. In the case where the plurality of temperature sensor lines 108 are provided as in this embodiment, an average of temperatures detected by the plurality of temperature sensor lines 108 may be used. Alternatively, for example, an average of resistance change ratios of the plurality of temperature sensor lines 108 may be used to calculate the temperature.

### Embodiment 3

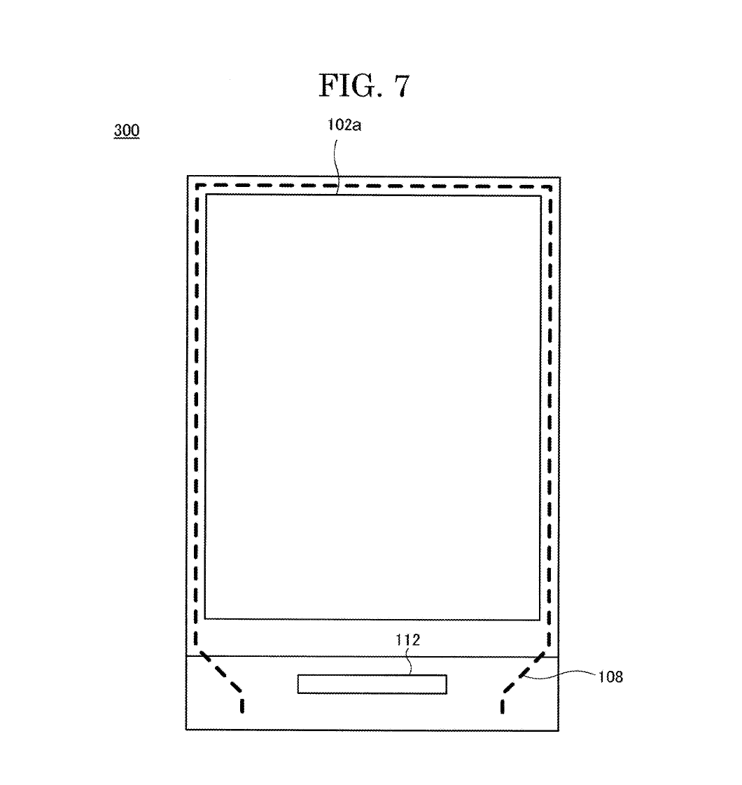

With reference to the drawings, a structure of a display device 300 in embodiment 3 will be described. FIG. 7 is a plan view showing the structure of the display device 300 in this embodiment. The display device 300 in this embodiment is different in the layout of the temperature sensor line 108 from the display device 100 in embodiment 1.

In this embodiment, at least a part of the temperature sensor line 108 is located around the display region 102a. In the case where the temperature sensor line 108 is not provided in the display region 102a but is located around the display region 102a as in this embodiment, there is no limitation on the layout of the lines in the display region 102a.

### Embodiment 4

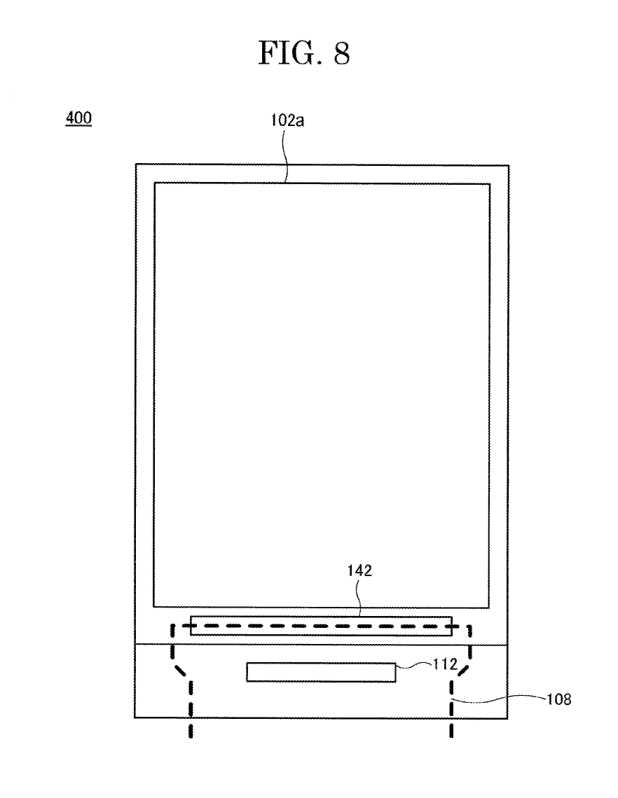

With reference to the drawings, a structure of a display device 400 in embodiment 4 will be described. FIG. 8 is a plan view showing the structure of the display device 400 in this embodiment. Unlike the display device 100 in embodiment 1, the display device 400 in this embodiment further includes an investigation circuit 142. The investigation circuit 142 is located between the display region 102a and the end of the first substrate 102, and is also referred to as a peripheral circuit. The investigation circuit 142 is connected with the plurality of pixel circuits 128, and is provided to investigate the quality of the plurality of pixel circuits 128. The quality investigation is performed during the production of the display device 400, before the driver IC 112 is mounted. The conventional display device includes an investigation circuit, but the investigation circuit is not involved in the driving of the display device while the display device is used as a product.

Unlike the investigation circuit in the conventional display device, the investigation circuit 142 is involved in the driving of the display device 400 while the display device 400 is used as a product. The display device 400 in this embodiment uses a line of the investigation circuit 142 as the temperature sensor line 108. Namely, at least a part of the temperature sensor line 108 in the temperature sensor circuit 120 is shared with the investigation circuit 142. Hereinafter, a structure of the investigation circuit 142 will be described in detail.

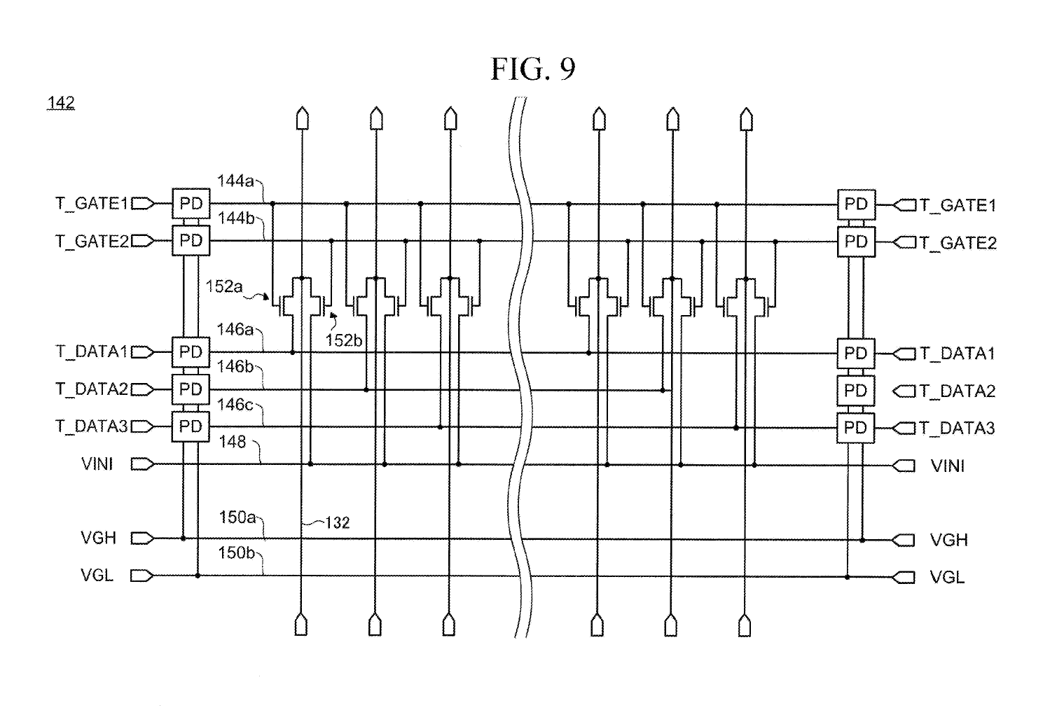

FIG. 9 is a circuit diagram showing the structure of the investigation circuit 142 included in the display device 400 in this embodiment. The investigation circuit 142 included in the display device 400 in this embodiment includes a first control signal line 144a, a second control signal line 144b, a first analog signal line 146a, a second analog signal line 146b, a third analog signal line 146c, an initialization signal line 148, a first power supply potential line 150a, a second power supply potential line 150b, a plurality of first control switches 152a, a plurality of second control switches 152b, and a plurality of protective diodes PD.

The first and second control signals 144a and 144b are located to cross the plurality of video signal lines 132. The first through third analog signal lines 146a through 146c are located to cross the plurality of video signal lines 132. The plurality of first control switches 152a each connect the corresponding one of the plurality of video signal lines 132 and one of the first through third analog signal lines 146a through 146c to each other. A control terminal of each of plurality of first control switches 152a is connected with the first control signal line 144a. The plurality of second control switches 152b each connect the corresponding one of the plurality of video signal lines 132 and the initialization signal lines 148 to each other. A control terminal of each of the plurality of second control switches 152b is connected with the second control signal line 144b. The plurality of protective diodes PD are respectively connected with both of two ends of the first and second control signal lines 144a and 144b and the first through third analog signal lines 146a through 146c. The first power supply potential line 150a and the second power supply potential line 150b are connected with the plurality of protective diodes PD, and each supply a power supply VGH or VGL to the protective diodes PD.

Now, a quality investigation method performed by use of the investigation circuit 142 will be described. A signal T_GATE1 is input to both of the two ends of the first control signal line 144a. The signal T_GATE1 controls the plurality of first control switches 152a to be on or off. When the plurality of first control switches 152a are on, either one of signals T_DATA1 through T_DATA3 is input to each of the plurality of video signal lines 132. As a result, either one of the signals T_DATA1 through T_DATA3 is input to each of a plurality of pixels 106 located in a pixel row selected among the plurality of pixels 106 in the display region 102a, and the light emission of the plurality of pixels 106 in the selected pixel row is investigated.

A signal T_GATE2 is input to both of the two ends of the second control signal line 144b. The signal T_GATE2 controls the plurality of second control switches 152b to be on or off. When the plurality of second control switches 152b are on, a signal VINI is input to each of the plurality of video signal lines 132. As a result, the signal VINI is input to each of a plurality of pixels 106 located in a pixel column selected among the plurality of pixels 106 in the display region 102a. The signal VINI corresponds to, for example, an initialization potential applied to the gate of the driving transistor 134 in threshold value compensation of the pixel 106. The structure of the investigation circuit 142 and the quality investigation method performed by use of the investigation circuit 142 have been described.

In this embodiment, at least one of the first and second control signal lines 144a and 144b, the first through third analog signal lines 146a through 146c, the initialization signal line 148, and the first and second power supply potential lines 150a and 150b is used as the temperature sensor line 108.

With such a structure, the display device 400 does not need to include the temperature sensor line 108 provided separately. Since the temperature sensor line 108 does not need to be provided, for example, around the display region 102a, a temperature sensor is provided with no need to enlarge a frame region around the display region 102 that does not contribute to display.

As described above in each of the embodiments, the display device according to the present invention includes the temperature sensor line 108 and detects the temperature of the display device based on the temperature dependence of the resistance change ratio of the temperature sensor line 108. The display device in this embodiment, because of this structure, keeps the detected temperatures less dispersed than a display device detecting the temperature based on the temperature dependence of the value of the line resistance. In other words, the display device according to the present invention measures the temperature highly precisely.

### EXAMPLE

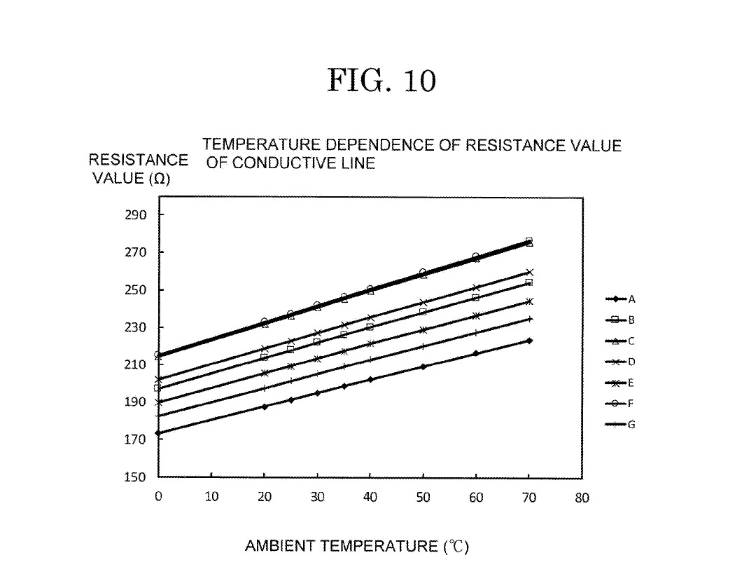

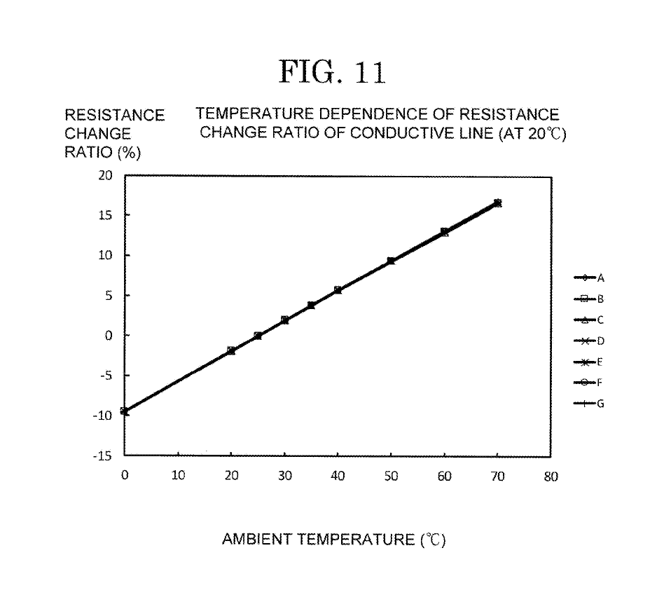

Now, the degree of dispersion among the temperatures detected by seven display devices (sample A through sample G) each including the temperature sensor line 108 will be described. FIG. 10 shows measurement data representing the relationship between the sensed resistance value (Rₛₑₙₛₑ) and the temperature (T) of the temperature sensor line 108 in each of sample A through sample G. FIG. 11 shows measurement data representing the relationship between the resistance change ratio and the temperature of the temperature sensor line 108 in each of sample A through sample G. The resistance change ratio shown in FIG. 11 is calculated from the resistance value shown in FIG. 10. The resistance change ratio was calculated as being (Rₛₑₙₛₑ−R_{ref})/R_{ref}. The reference temperature (T_{ref}) was set to 25° C., and the reference resistance (R_{ref}) was set as the resistance of the temperature sensor line 108 sensed at 25° C.

As seen from FIG. 10 and FIG. 11, the resistance value and the resistance change ratio both change substantially linearly with respect to the temperature. The relationships between the resistance value and the temperature shown in FIG. 10 are dispersed among the samples more than the relationships between the resistance change ratio and the temperature shown in FIG. 11. This dispersion is caused by, for example, the shape of the temperature sensor line 108, for example, the length, width or the like of the temperature sensor line 108. Namely, in the case where the resistance value of the temperature sensor line 108 is used to sense the temperature of the display device, the shift, from the designed value, of the shape of the temperature sensor line 108 is reflected more than in the case where the resistance change ratio of the temperature sensor line 108 is used. Thus, the resistance change ratio may be used instead of the resistance value, so that the shift, from the designed value, of the shape of the temperature sensor line 108 is not much reflected. As a result, more precise temperature sensing is realized.

In a display device including a plurality of temperature sensor lines 108, the relationships between the resistance value and the temperature are dispersed among the plurality of temperature sensor lines 108 more than the relationships between the resistance change ratio and the temperature. Therefore, in the case where the resistance value is used to sense the temperature, it is needed to acquire the relationship between the resistance value and the temperature of each of the plurality of temperature sensor lines 108 and store the relationship on a memory included in the display device because of the above-described dispersion is large.

By contrast, in the case where the resistance change ratio is used to sense the temperature of the display device including a plurality of temperature sensor lines 108, the relationship between the resistance change ratio and the temperature is determined almost uniquely because the dispersion among the temperature sensor lines 108 is small. Therefore, only the relationship between the resistance change ratio and the temperature determined uniquely may be stored on the memory in the display device.

The measurement data on the temperature dependence of the resistance value and the resistance change ratio of the plurality of temperature sensor lines 108 included in the display device has been described. In the display device in this embodiment, the temperature dependence of the resistance change ratio of each of the temperature sensor lines 108 is used, instead of the temperature dependence of the resistance value of each of the temperature sensor lines 108, to detect the temperature of the display device. With such a structure, the detected temperatures are kept little dispersed. In other words, the temperature is sensed highly precisely. Thus, even if the temperature environment of the display device is changed, the level of the cathode current is kept constant, and the change in the level of the luminance emitted by the display device is suppressed.

What is claimed is:

1. A display device, comprising:
a plurality of pixels provided on a substrate, the plurality of pixels each including a light emitting element and a pixel circuit to which a gray scale signal is input;
a temperature sensor circuit provided on the substrate, the temperature sensor circuit including a temperature sensor line and detecting a temperature on a basis of a temperature dependence of a resistance change ratio of the temperature sensor line; and
a gray scale signal control circuit correcting the gray scale signal in accordance with the temperature.

2. The display device according to claim 1, wherein at least a part of the temperature sensor line is located in a display region where the plurality of pixels are located.

3. The display device according to claim 1, wherein at least a part of the temperature sensor line is located around a display region where the plurality of pixels are located.

4. The display device according to claim 1, wherein at least a part of the temperature sensor line is located in a same layer as that of a scanning signal line or a video signal line connected to each of the plurality of pixels.

5. The display device according to claim 1, further comprising:
a display region where the plurality of pixels are located; and
a peripheral circuit located between the display region and an end of the substrate, the peripheral circuit being connected with the pixel circuit;
wherein at least a part of the temperature sensor line is shared with a line of the peripheral circuit.

6. The display device according to claim 5, wherein:
the peripheral circuit includes:
a signal line to be supplied with a signal to be input to the plurality of pixels;
a plurality of switches; and
a plurality of diodes; and
the peripheral circuit switches the light emitting element to be on or off.

7. The display device according to claim 5, wherein:
the peripheral circuit includes a power supply line to which a power supply potential is applied; and
the power supply line is used as the temperature sensor line.

8. The display device according to claim 1, further comprising a temperature gain acquisition circuit connected with the temperature sensor circuit, the temperature gain acquisition circuit determining a gain of the gray scale signal in accordance with the temperature;
wherein the gray scale signal control circuit includes a gray scale signal correction circuit correcting the gray scale signal in accordance with the gain.

9. The display device according to claim 8, wherein:
the light emitting element includes an anode, a light emitting layer and a cathode stacked in this order; and
the temperature gain acquisition circuit determines the gain so as to decrease the temperature dependence of a current passing the anode.

10. The display device according to claim 1, wherein the temperature sensor circuit detects the temperature at a predetermined cycle while the plurality of pixels are driven.

11. The display device according to claim 1, wherein the resistance change ratio is calculated on a basis of a resistance value of the temperature sensor line at a predetermined reference temperature.

12. The display device according to claim 1, wherein the gray scale signal control circuit further includes a gamma correction circuit correcting the gray scale signal in accordance with a gamma value of the gray scale signal.

13. A display device, comprising:
a plurality of pixels provided on a substrate, the plurality of pixels each including a light emitting element;
a line located on the substrate;
a sensor circuit sensing a resistance change of the line; and
a control circuit correcting a luminance of light to be emitted by the light emitting element on a basis of a resistance change.

14. The display device according to claim 13, wherein the sensor circuit senses a temperature change on a basis of a ratio of the resistance change of the line.

15. The display device according to claim 13, wherein the control circuit corrects a gray scale level of a video signal input to the plurality of pixels.

16. The display device according to claim 13, wherein the control circuit corrects a level of a current flowing to the light emitting element.

17. The display device according to claim 13, wherein the line is a power supply line.

18. The display device according to claim 13, further comprising:
a display region where the plurality of pixels are located; and
a peripheral circuit provided between the display region and an end of the substrate;
wherein:
the plurality of pixels include a plurality of pixel circuits respectively;
the peripheral circuit is connected with the pixel circuits, and switches the light emitting element to be on or off; and
the line is included in the peripheral circuit.

19. The display device according to claim 13, further comprising a display region where the plurality of pixels are located;
wherein a part of the line is located in the display region and includes at least one first portion extending in a first direction and at least one second portion extending in a second direction crossing the first direction.

20. The display device according to claim 19, wherein the at least one first portion comprises a plurality of first portions, and
the at least one second portion comprises a plurality of second portions.
